(19) United States
(12) Patent Application Publication
(10) Pub. No.: US 2006/0221870 A1
(43) Pub. Date: Oct. 5, 2006

(54) Image communication method and communication apparatus

(76) Inventors: Goichi Morikawa, Ome-shi (JP); Kenichi Tabe, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/395,042

(22) Filed: Mar. 31, 2006

(30) Foreign Application Priority Data
Mar. 31, 2005 (JP) 2005-105212

(51) Int. Cl. H04L 12/16; H04L 12/66

(52) U.S. Cl. 370/260; 370/352

(57) ABSTRACT

According to one embodiment, an image communication method for transmitting image data between a first terminal and a second terminal via a network, the method includes performing a bidirectional image communication including a transmission of first image data from the first terminal to the second terminal and a transmission of second image data from the second terminal to the first terminal, performing a notification to stop either transmission of the first image data or the second image data from one to the other of the first terminal and the second terminal, and stopping either transmission of the first image data or the second image data depending on the notification to perform a one-way image communication between the first terminal and the second terminal.

### CROSS-REFERENCE TO RELATED APPLICATIONS

This application is based upon and claims the benefit of priority from the Japanese Patent Application No. 2005-105212, filed Mar. 31, 2005, the entire contents of which are incorporated herein by reference.

### BACKGROUND

1. Field

One embodiment of the invention relates to an image communication method and a communication apparatus, for example, for making a bidirectional communication of image data among a plurality of terminals connected to a network.

2. Description of the Related Art

Sometimes, a user does not want user image to be displayed at the opposite party's terminal. A technique which transmits a mute image as a substitute for the user image to the opposite party's terminal to notify the fact that the user image is now muted when the user does not display the user image is already known, [(0005), (0013), (0015), (0020), (0031), (0034) and (0035), FIGS. 1, 5, 6 and 7, Japanese Patent Application Publication (KOKAI) No. 6-233289].

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a whole configuration of a visual communication (hereinafter referred to as VC) system regarding a first embodiment;

FIG. 2 is an exemplary block diagram showing a schematic configuration of a client regarding the first embodiment;

FIG. 3 is an exemplary communication sequence chart of video sessions of a VC client regarding the first embodiment;

FIG. 4 is an exemplary view showing a display image of a display device of the VC client in a bidirectional image communication;

FIG. 5 is an exemplary view showing a display image of the display device of the VC client in a one-way image communication;

FIG. 6A, FIG. 6B, and FIG. 6C are an exemplary view showing a user interface window of an application-sharing regarding a second embodiment;

FIG. 7 is an exemplary view showing transitions of setting states/operable states of each button of ‘Start/Stop:’;

FIG. 8 is an exemplary view showing transitions of setting states/operable states of each button of ‘Receive Editability:’; and

FIG. 9 is an exemplary view showing transitions of setting states/operable states of ‘Material Window View Mode:’.

### DETAILED DESCRIPTION

Various embodiments according to the invention will be described hereinafter with reference to the accompanying drawings. In general, according to one embodiment of the invention, an image communication method for transmitting image data between a first terminal and a second terminal via a network, the method comprises: performing a bidirectional image communication including a transmission of first image data from the first terminal to the second terminal and a transmission of second image data from the second terminal to the first terminal; performing a notification to stop either transmission of the first image data or the second image data from one to the other of the first terminal and the second terminal; and stopping either the transmission of the first image data or the second image data depending on the notification to perform a one-way image communication between the first terminal and the second terminal.

### First Embodiment

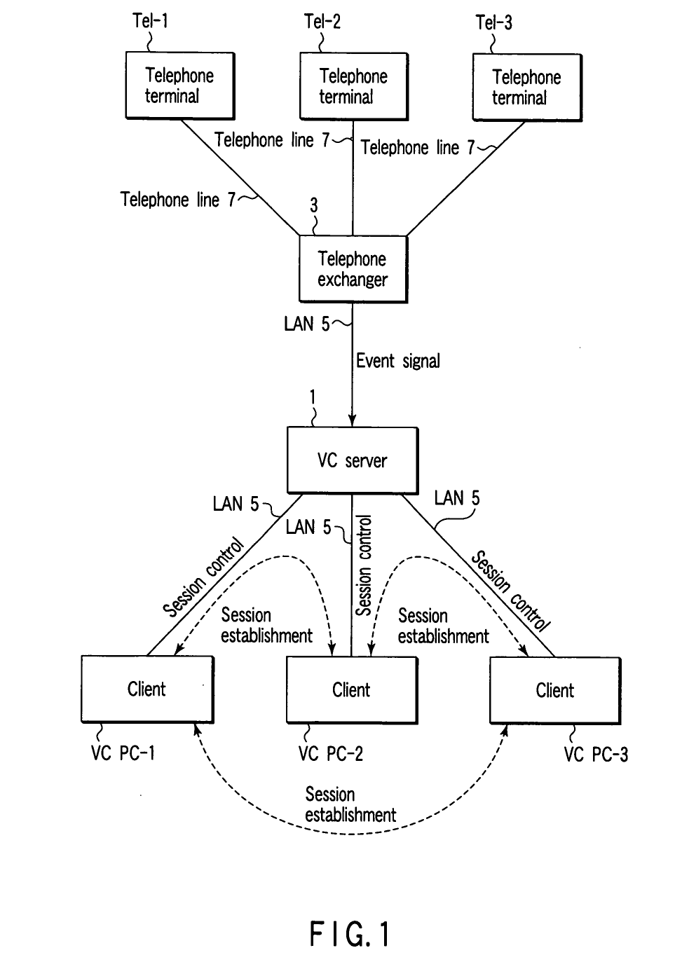

FIG. 1 is the exemplary view showing the whole configuration of the VC system regarding the first embodiment of the present invention

As shown in FIG. 1, the VC system of the first embodiment comprises a telephone exchanger 3; at least one set of telephone terminals Tel-1 to Tel-3 connected to the exchanger 3 via a telephone line 7; a VC server 1 as a server computer connected to the exchanger 3 via an IP network such as a local area network (hereinafter referred to as LAN) 5; and at least one VC client VC_PC-1 to VC_PC-3 as a client computer connected to the VC server 1 via the LAN 5.

Functions of the telephone terminal Tel-1 to Tel-3 are achieved by software (soft phones) installed in VC clients VC_PC-1 to VC_PC-3, respectively and the functions use the LAN 5 as the telephone line 7.

The exchanger 3 detects operations of the telephone terminals Tel-1 to Tel-3. That is, the exchanger 3 detects the operations of the telephone terminals Tel-1 to Tel-3 via the telephone line 7 to perform line exchange procedures in response to the detected operations. When a certain telephone terminal makes a call (outgoing telephone number) to the opposite party's telephone terminal, the exchanger 3 detects the fact that the telephone terminals have been brought into states communicable with each other and allows them to make voice sound communications.

In addition, the exchanger 3 also detects an operation in outgoing/incoming calls while one telephone terminal Tel-1 makes a telephone call to an opposite party. The operation of the outgoing/incoming calls includes an outgoing operation of the telephone number of the telephone terminal, an incoming ringing from the opposite party's telephone terminal or the like. That is, the operations of the outgoing/incoming calls are operations of each telephone terminal Tel-1 to Tel-3 when the telephone terminals Tel-1 to Tel-3 make telephone calls, receive telephone calls or disconnect telephone calls, respectively.

Each VC client VC_PC-1 to VC_PC-3 is a usual computer each provided with a CPU, a memory, a display, a keyboard, a mouse, a hard disk device a LAN interface (hereinafter referred to as LAN_I/F), a USB interface (hereinafter referred to as USB_I/F) and the like.

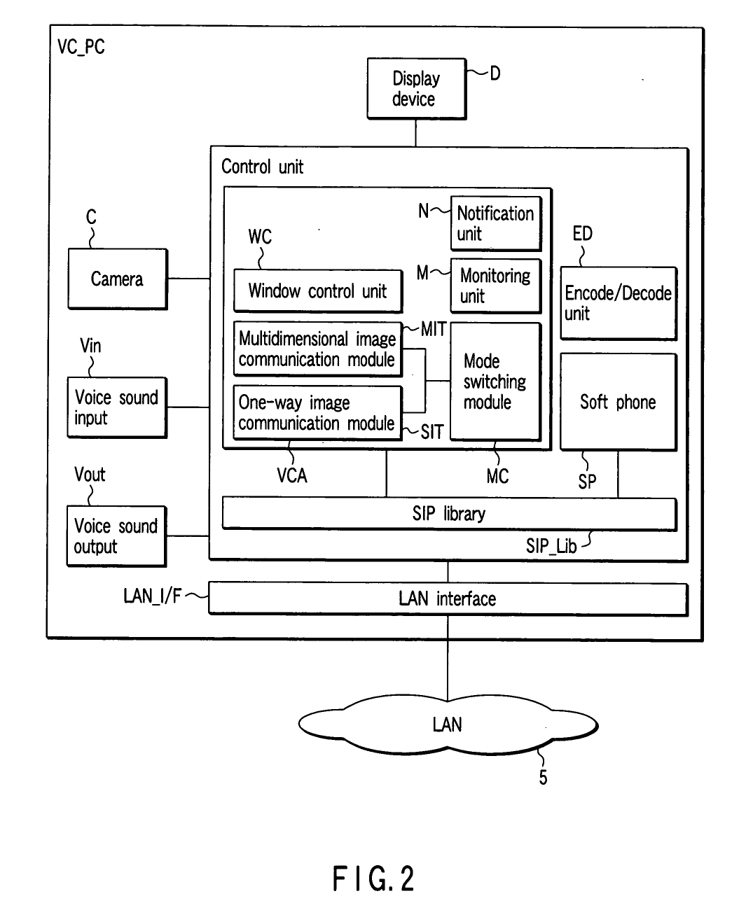

FIG. 2 is an exemplary block diagram showing the schematic configuration of the client.

The LAN_I/F is connected to the LAN 5. A control unit is connected to the LAN_I/F.

The client mounts a session initiation protocol (SIP) library SIP_Lib in order to make a communication such as session control and a registration of client information through an application layer. A TCP/IP installed in an operation system (herein after referred to as OS) makes a communication with the VC server 1 via the LAN 5 so as to transmit/receive a message in the SIP to and from the VC server 1.

The control unit includes a mode switching module MC, a multidimensional image communication module MIT, a one-way image communication module SIT, a window control unit WC, a monitoring unit M and a notification unit N.

A camera C is disposed to photograph a bust image of a person being in front of the VC client. The image photographed by the camera C is encoded by an encode/decode unit ED to be generated as image data. The encode/decode unit ED decodes the image data transmitted from the VC client VC_PC on the opposite party side to display it on a display device D. A function of the encode/decode unit ED may be realized with hardware and may also be realized by executing software of an encode/decode function through the CPU.

The monitoring unit M monitors loads of the encode/decode unit ED and the LAN 5. The notification unit N notifies a stoppage of a transmission of the image data or a change in setting thereof to the client of the communication partner.

During the communication, a voice sound is input from a voice sound input Vin and the input voice sound is transmitted to the VC client on the opposite party side through a soft phone SP. The soft phone SP outputs the voce data transmitted from the VC client on the opposite party side from a voice sound output Out.

Client software to display a television conference screen to achieve a VC function and take in a video (image) of a speaker photographed by the camera C to transmit it to the VC server 1 has been installed in the hard disk device. The hard disk device also stores the soft phone to achieve a function of a telephone terminal therein.

A client ID being identification information of its own client and a telephone number being identification information of a telephone terminal to be associated are registered correspondingly to each other in the memory, as client information.

The function of the client software includes a communication function with the VC server 1 and a log-in function to the VC-server 1 and the CPU achieves those functions in cooperation with the memory or the like.

The communication function with the VC server 1 performs a transmission/reception of a signal relating to session control to/from the VC server 1 and performs a transmission/reception to make log-in the client information such as the client ID and the corresponding telephone number stored in the memory to the VC server 1.

The VC server 1 is a computer provided with a CPU, a memory, a display, a keyboard, a mouse, a hard disk device, a LAN interface (hereinafter referred to as LAN_I/F), etc.

An OS and server software are installed in the hard disk device. The software, for example, the OS and the server software and the aforementioned hardware achieve the VC function in cooperation with one another.

In the VC system, a telephone exchanger notifies a combination of telephone terminals in the midst of voice communications to a VC server. The VC server notifies the combination to all clients corresponding to the notified telephone terminals. At this time, the VC server notifies an IP address and a port number of a client of a communication partner. When making a video communication, the VC server performs a start request of the video communication and a transmission/reception of image data to the IP address and port number of the notified client.

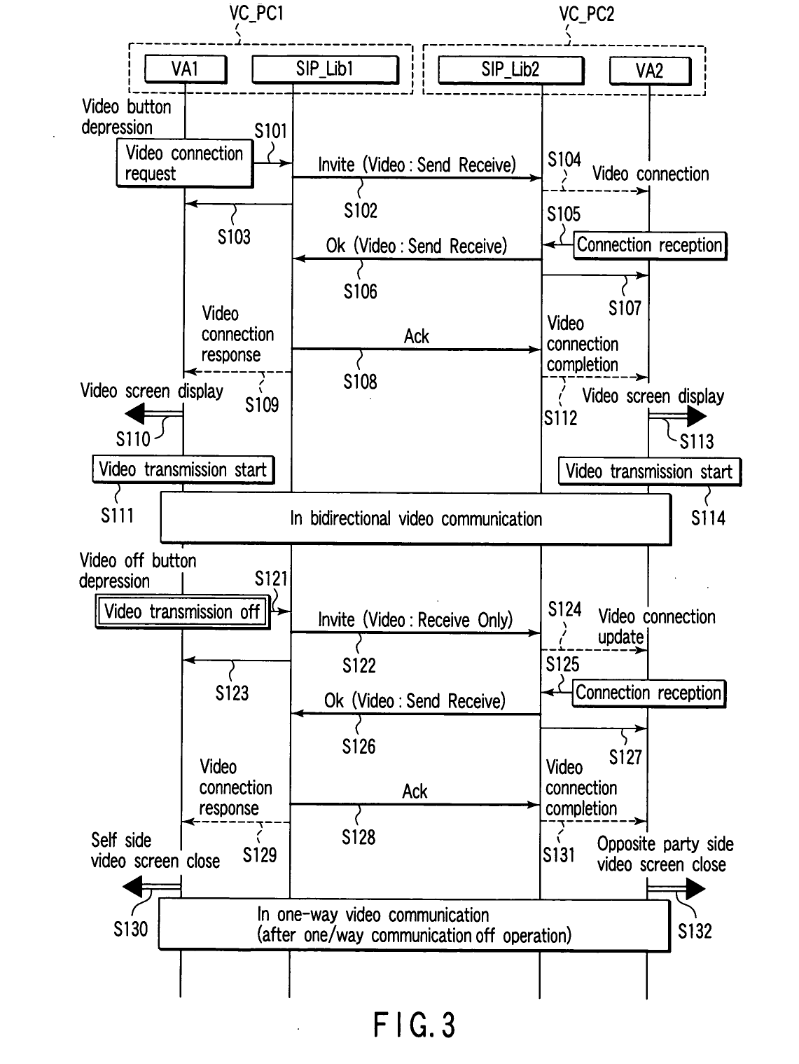

Procedures from the start of the video session between the two sets of the VC clients until a stoppage of a transmission of the image data will be described by referring to the communication sequence chart in FIG. 3.

When the user operates a video button of a video application VA1 installed in the VC client VC_PC-1 (first terminal), the video application VA1 notifies the fact of ‘video connection request’ to the SIP library SIP_Lib1 (step S101). The SIP library SIP_Lib1 transmits ‘Invite (Video: Send/Receive)’ to the VC client VC-PC-2 in response to the notification of the ‘video connection request’ (step S102). The ‘Invite (Video: Send/Receive)’ includes information about a resolution, a frame rate and a bit rate of a video allowed to be transmitted and received by the VC client VC_PC-1. The SIP library SIP_Lib1 notifies, to the video application VA1, the fact of the transmission of the ‘Invite (Video: Send/Receive)’ to the VC client VC_PC-2 (step S103).

The SIP library SIP_Lib2 notifies a ‘video communication request’ to the video application VA2 in response to the ‘Invite (Video: Send/Receive)’ (step S104). The video application VA2 notifies a ‘connection reception’ to the SIP library SIP_Lib2 in response to the ‘video connection notification’ (step S105). The SIP library SIP_Lib2 replies ‘Ok (Video: Send/Receive)’ to the VC client VC_PC-1 in response to the ‘connection reception’ (step S106). The ‘OK (Video: Send/Receive)’ includes information about a resolution, a frame rate and a bit rate of a video allowed to be transmitted and received by the VC client VC_PC-2 (second terminal). The SIP library SIP_Lib2 notifies, to the Video application VA2, the fact of making a reply of (Ok Video: Send/Receive)’ to the video application VA1.

The SIP library SIP_Lib1 replies ‘Ack’ to the VC client VC_PC-2 in response to the (Ok Video: Send/Receive)’ (step S108).

When the VC client VC_PC-2 side has received the ‘Ack’, a session between the VC client VC_PC-1 and the VC_PC-2 is established.

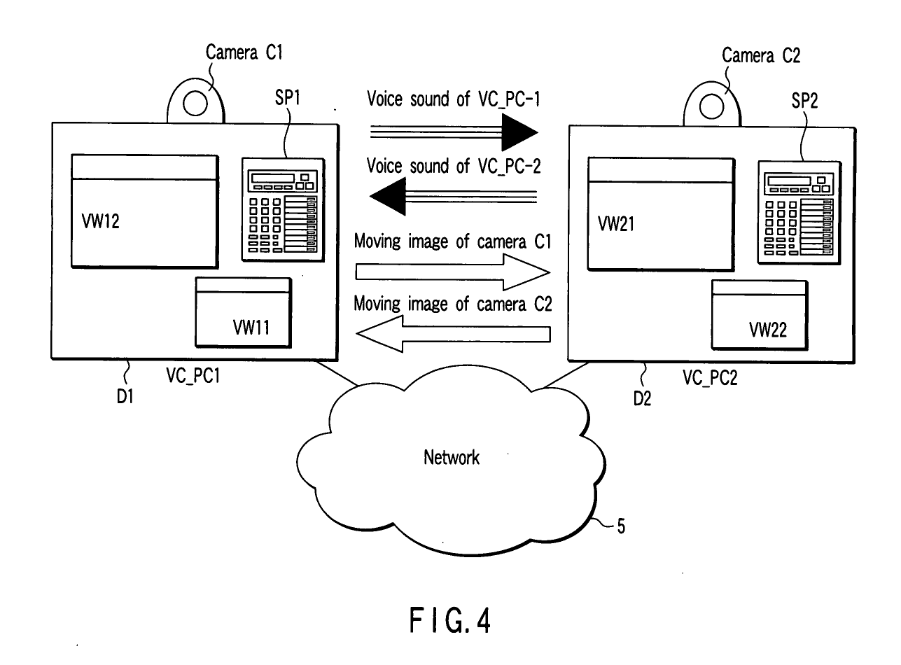

The SIP library SIP_Lib1 notifies, to the video application VA1, the fact that the VC client VC_PC-2 has responded to the ‘video connection request (step S101)’ (step S109). The video application VA1, as shown in FIG. 4, displays video windows VW11 and VW12 on a display device D1 (step S110), photographs by a camera C1 on the VC client VC_PC1 side and transmits the image data encoded by the encode/decode unit ED to the VC client VC_PC-2 (step S111). The video window VW11 displays the image photographed by the camera C1 on the VC client VC_PC-1 side and the video window VW12 displays the image obtained by decoding the image data, transmitted from the VC client VC_PC-2 to the VC-client VC_PC-1, by means of the encode/decode unit ED.

The resolutions, frame rates and bit frames of the image data to be performed in bidirectional image communication between the VC client VC_PC-1 client and the VC client VC_PC-2 are the same as each other. The steps S102 and S106 exchange the resolutions, the frame rates and the bit rates with each other, however, the resolutions, the frame rates and the bit rates of the image data to be brought into the bidirectional image communication are matched to those of the VC client having low performance.

The SIP library SIP_Lib2 responds to the ‘Ack’ to notify ‘video connection completion’ to the video application VA2 (step S112). The video application VA2 displays the video windows VW21 and VW22 on a display device D2 in response to the ‘video connection completion’ (step S113) and transmits the image photographed by the camera C2 on the VC client VC_PC2 side to the VC client VC_PC-1 (step S114). The video window VW21 displays the image photographed by the camera C2 on the VC client VC_PC-1 side and the video window VW22 displays the image data transmitted from the VC client VC_PC-2 side.

The above-mentioned procedures enable bidirectional image data communication. In the bidirectional image data communication, mode switching module MCs of the VC client VC_PC-1 and the VC client VC_PC-2 selects the multidimensional image communication module MIT, then the transmission/reception of the image data is performed.

If a user 1 intends to stop a transmission of a video to the VC client VC_PC-2 for some reason during bidirectional video communication, the user 1 operates a video button of the video application VA1. When the video button of the video application VA1 is operated during the bidirectional video communication, a notification unit N1 notifies ‘video transmission off’ to the SIP library SIP_Lib1 (step S121). The SIP library SIP_Lib1 transmits the ‘Invite (Video: Receive only)’ to the VC-client VC_PC-2 in response to the ‘video transmission off’ (step S122). The SIP library SIP_Lib 1 notifies the fact of the transmission of the ‘Invite (Video: Receive only)’ to the VC client VC_PC2, to the video application VA1 (step S123).

The SIP library SIP_Lib2 notifies ‘video connection update’ to the video application VA2 in response to the ‘Invite (Video: Receive only)’ (step S124). The video application VA2 notifies a ‘connection reception’ to the SIP library SIP_lib2 in response to the ‘video connection update’ (step S125). The SIP library SIP_lib2 transmits ‘Ok (Video: Send/Receive)’ to the VC client VC_PC-1 in response to the ‘connection reception’ (step S126). The SIP library SIP_Lib2 notifies the fact of the transmission of the ‘Ok (Video: Send/Receive)’ to the VC client VC_PC1, to the video application VA2 (step S127).

The SIP library SIP_Lib1 transmits ‘Ack’ to the VC client VC_PC-2 in response to the ‘Ok (Video: Send/Receive) (step S128).

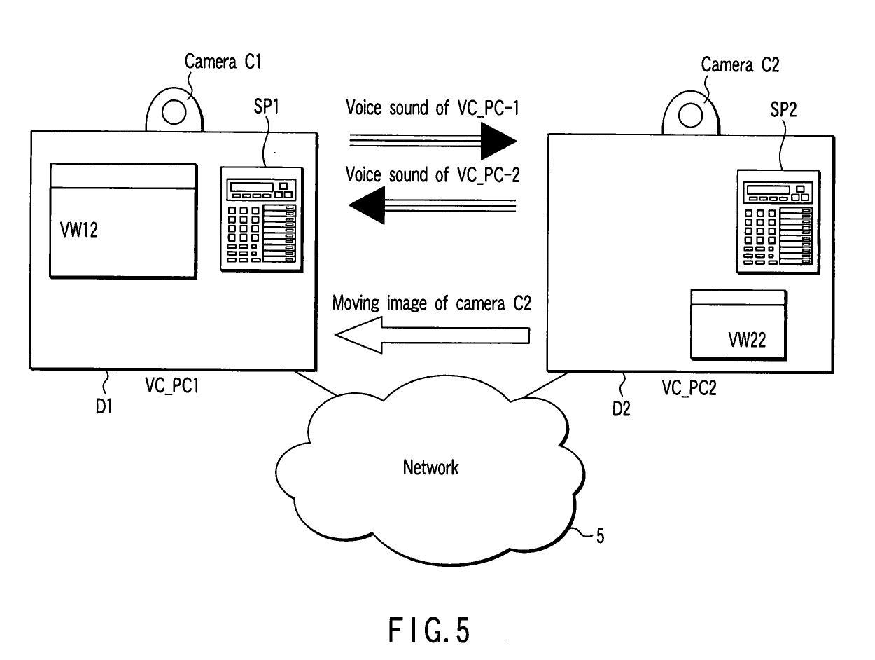

The SIP library SIP_Lib1 notifies the fact of the response from the VC client VC_PC-2 in response to the ‘video off (step S121)’ (‘video connection response’) (step S129). When the ‘video connection response’ has been notified, a mode switching module MC1 selects a one-way image communication module SIT1. The communication module SIT1, as shown in FIG. 5, stops photographing of the camera C1 to shut the video window VW11 (step S130).

The SIP library SIP_Lib2 notifies ‘video connection completion’ to the video application VA2 in response to the ‘Ack’ (step S131). A mode switching module MC2 selects a one-way image communication module SIT2 in response to the notification of the ‘video connection completion’. The communication module SIT2, as shown in FIG. 5, shuts the video window VW21 to display video data transmitted from the VC client VC_PC-1 side (step S132).

The aforementioned processing does not transmit image data from the VC client VC_PC-1 to the VC client VC_PC-2 but transmits image data from the VC client VC_PC-2 to the VC client VC_PC-1 to perform the one-way image communication.

During the one-way image communication, by shutting the video window VW21 of the image data, the user comes to know the fact that the image has not been displayed due to a problem but the transmission of the image data has been stopped in accordance with notification from the VC client VC_PC-1.

The procedure may use an effect of a window closing with a message property in such a manner that a screen becomes small gradually and disappears so that a user of the VC client VC_PC-2 can easily comprehend stoppage of a video transmission by the communication partner as regards shutting the video window VW21.

In the procedure, the monitoring unit M of the receiving side client may detect the fact of no existence of received moving image data or an imperfection thereof at the time of disconnection of communication or extreme deterioration in communication quality caused by a network failure to continue a display of the final image data as a still image. In this case, since the display form is different from that in the one-way image communication, the user can recognize that a problem has occurred in the LAN 5 and it is impossible to normally receive the image data.

An example has been described, wherein the VC client VC_PC-1 notifies the stoppage of the transmission of the image data from the VC client VC_PC-1 and shuts the video window 21 which has been displaying the image data transmitted from the VC client VC_PC-1.

However, it is also possible for the VC client VC_PC-1 to instruct the stoppage of the transmission of the image data to the VC client VC_PC-2. In this case, in the step S122, the ‘Invite (Video: Second only)’ may be transmitted as a substitute for the ‘Invite (Video: Receive only)’ to the VC client VC_PC-2.

Having instructing the stoppage of the transmission of the image data by the user in the aforementioned example, it is also possible to automatically notify the stoppage of the transmission of the image data. For example, when the monitoring unit M has detected that the load on the decode/encode unit ED is heavy, the notification unit N notifies that the sending image data to the client on the opposite side will be stopped. The stoppage of the transmission of the image data causes encode processing to be stopped and the processing load on the encode/decode unit ED to be reduced.

When the monitoring unit M recognizes the line conditions of the LAN 5 and the procedures cannot perform the bidirectional image communication, the notification unit N may notify to stop the transmission of the image data from one VC client. Either the VC client of the transmission side or the reception side of the ‘Invite (Video: Send/receive)’ may recognize the line conditions of the LAN 5. The first embodiment may be configured in that the VC server 1 monitors the line conditions and instructs to make one VC client stop the transmission of the image data and the instructed VC client notifies to the VC client on the opposite party's side so as to perform the one-way image communication.

The first embodiment may be configured to reset the resolution, the frame rate and the bit rate depending on the load of the encode/decode unit ED and notify them to the VC client on the opposite party's side. With resetting of the resolution, the frame rate and the bit rate, the processing load at the decode/encode unit ED can be reduced. The first embodiment may reset the resolution, the frame rate and the bit rate depending on the line conditions of the LAN 5 to notify them to the VC client on the opposite party's side.

The notification, from the VC client 1, of image information (second image information) including the resolution, the frame rate and the bit rate different from those of the image data which has been brought into the bidirectional image communication to the VC client 2 on the opposite party's side allows the bidirectional image communication of the image data generated on the basis of the new image information to be performed.

### Second Embodiment

The VC system described in the first embodiment of the invention has an application-sharing function. The application-sharing function includes a function to display a window of an application which has been running on a PC of one communication peer (self or communication partner) onto a display device of a VC client on the other communication peer (communication partner or self). Such a state of sharing an application is referred to as an application-sharing state. The application-sharing may be started from any two communication peers, however if one becomes a transmission side then the other becomes a reception side. A client which has become the reception side is not allowed to become the transmission side until the application-sharing is terminated. In this case, the side with the application running thereon is referred to as a transmission side and a side with a window displayed thereon is referred to as a reception side.

An operation of a mouse cursor on the transmission side during application-sharing is reflected on an application-sharing screen of the reception side similarly. On the reception side of the application-sharing, there is no need for an application corresponding to a shared window to be installed in a PC. The application-sharing in an original-size display mode makes it possible to operate the shared application even on the reception side to edit content (joint editing function).

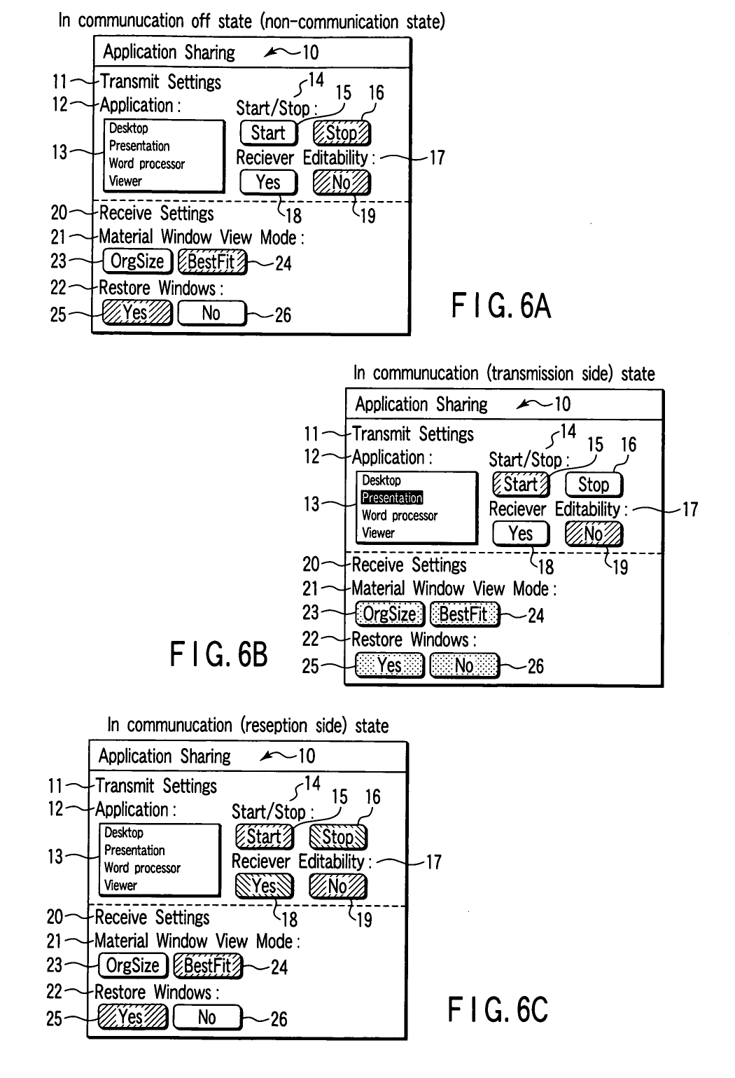

FIG. 6 is a user interface (UI) window driving application-sharing. The user operates the UI window to select the use of the application-sharing. The application-sharing has, as shown in FIG. 6, two states of ‘non-communication state’ and ‘communication state’. In the ‘communication state’, as shown in FIG. 6, in each communication peer, one becomes a ‘transmission side’ to transmit a running-application screen on a self side PC and the other becomes a ‘reception side’ to reflect an application screen of the ‘transmission side’ thereon.

FIG. 6A shows the UI window in the non-communication state, in which the transmission side and reception side has not been decided between each of the communication peers. A UI window shown in FIG. 6B shows a state, in which the communication peers are in communication states and also its self side is decided as a transmission side. A UI window shown in FIG. 6C shows a state, in which the communication peers are in communication states and also its self side is a reception side.

In terms of each UI arranged in each application-sharing window, ‘Application sharing’ 10 at the top of the window indicates a window title. In ‘Transmit settings’ 11, ‘Application:’ 12 includes a list 13 to select the shred applications as setting of a transmission side and as an operation UI. ‘Start/Stop’ 14 has a ‘Start’ button 15 and a ‘Stop’ button 16 to operate the start/stop of the application-sharing. ‘Receive Editability:’ 17 has a ‘Yes’ button 18 and a ‘No’ button 19 to set ‘Yes’ or ‘No’ to vest an editing right for the shared application to the reception side.

‘Receive Settings’ 20 has ‘Material Window View Mode:’ 21 and ‘Restore Windows:’ 22 as setting of the reception side and as the UI. The ‘Material Window View Mode:’ 21 has an ‘Original Size’ button 23 and a ‘Best Fit’ button 24 to set a display method of the shared application in the window. The ‘Original Size’ button 23 sets the window with the same size as that of the transmission side. The ‘Best Fit’ button 24 sets to produce a whole display by scaling to fit the window to the window size of the reception side.

The ‘Restore Window:’ 22 has a ‘Yes’ button 25 and a ‘No’ button 26 for setting whether or not to optimally arrange a plurality of windows so as not to be overlapped with one another.

The ‘non-communication state’ shown in FIG. 6A can set both ‘Transmit settings (transmission setting)’ 11 and ‘Receive Settings (reception setting)’. The selected setting is lit (for example, in blue). The setting of ‘Transmit Settings’ 11 will be used as an initial value when the application-sharing communication will be started (‘Start’ button depression) in the future. The setting of ‘Receive Settings’ will be used as an initial value when the communication peer is the reception side of the application-sharing.

The ‘communication state (transmission side)’ shown in FIG. 6B makes each button of the ‘Transmit Settings’ 11 operable. The start button 15 of the ‘Start/Stop’ 14 starts flashing to indicate the communication peer is now in a transmission state. The operation of the stop button 16 stops the application-sharing. In the ‘Receiver Editability’, the ‘No’ button 19 flashes to indicate that the reception side has no editing right. With an operation of the ‘Yes’ button 18, the reception side can obtain the editing right. Each button of the ‘Receive Settings’ become grayed-out (Disable state) because the transmission side is not received a state of the reception side.

The ‘communication state (reception side)’ shown in FIG. 6C cannot bring each button of the ‘Transmit settings’ 11 into operation. The ‘Start’ button 15 of the ‘Start/Stop:’ 14 flashes (Disable state) to indicate a transmission state of the opposite party side. The ‘Receiver Editability’ 17 indicates impossibility of editing at the reception side by flashing (Disable state) the ‘No’ button 19. Each button of the ‘Transmit Settings’ 11 is not operable because of their grayed-out (Disable) states.

‘Application-sharing communication (reception side) state’ enables each button of the ‘Receive Settings’ to be operated. The user can operate the ‘Best Fit’ button and the ‘Restore Window’ button of the ‘Material Window View Mode:’ 21 and either one set button is flashed. The ‘Application-sharing communication state’ allows the ‘Yes’ button 25 and ‘No’ button 26 of the ‘Restore Windows:’ 22 to be operated and either one set button to be flashed.

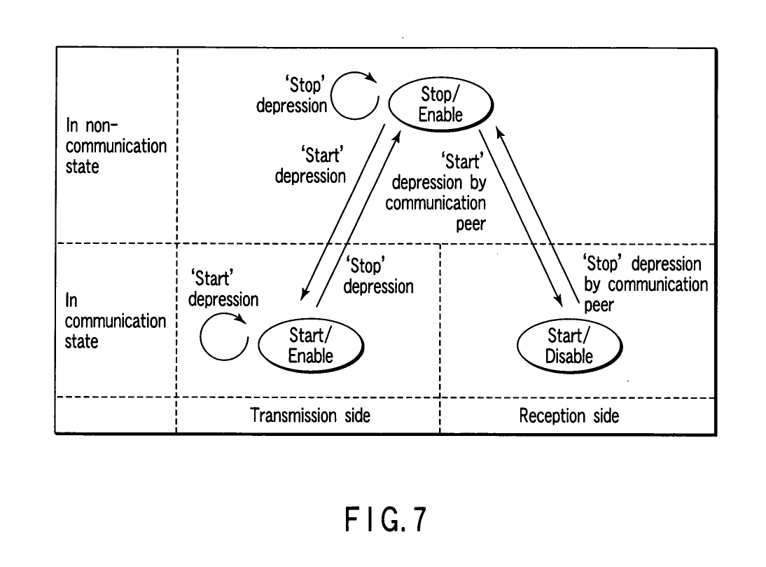

FIG. 7 to FIG. 9 are exemplary views showing transitions of setting states/operable states referring to three UIs, as example, of each button 15 and 16 of the ‘Start/Stop’ 14, each button 18 and 19 of the ‘Receive Editablity:’ 17, and each button 23 and 24 of the ‘Material Window View Mode:’ 21.

The transitions of the setting states/operable states of each button 15 and 16 of the ‘Start/Stop:’ 14 will be described with reference to FIG. 7. As shown in FIG. 7, when one client operates the ‘Start’ button 15, the ‘Start’ becomes ‘Enable’ and application-sharing function is performed to bring the communication peers into the communication states. At this moment, the side on which the ‘Start’ button 15 has operated becomes the transmission side and the other side becomes the reception side. While making the communication, the operation of the ‘Stop’ button 16 on the transmission side causes the application-sharing function to be stopped (non-communication state). In the communication state, the ‘Start’ is ‘Disable’ on the reception side then the user cannot operate the ‘Start’ button 15.

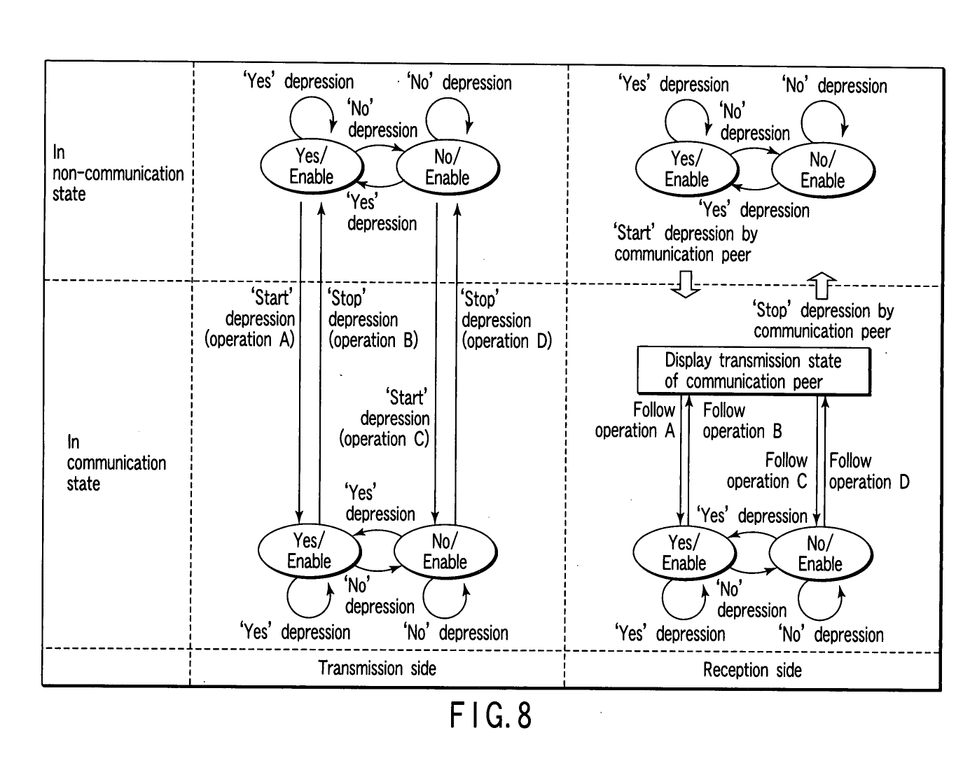

The transitions of the setting states/operable states of each button 18 and 19 of the ‘Receive Editablility:’ 17 will be explained by referring to FIG. 8. As shown in FIG. 8, the user can operate the ‘Yes’ button 18 and the ‘No’ button 19 of the ‘Receive Settings (reception setting)’ in the non-communication state. When the ‘No’ button 19 is operated in an enable state of ‘Yes/Enable’, ‘No/Enable’ turns to ‘Enable’. When the ‘Yes’ button 18 is operated in an enable state of ‘No/Enable’, the ‘Yes/Enable’ turns to ‘Enable’.

When the transmission side in the non-communication state sets the ‘Yes/Enable’ button to ‘Enable’, the operation of the ‘Start’ button 15 brings the communication peer into the communication state (operation A). At this time, the ‘Yes’ button 18 of the ‘Receiver Editablility’ flashes on the reception side then the user recognizes that the ‘Yes/Enable’ be ‘Enable’.

In the communication state, if the ‘Stop’ button 16 in the setting state of setting of ‘Yes/Enable’ to ‘Enable’ (operation B), the transmission side becomes the non-communication state while setting the ‘Yes/Enable’ to ‘Enable’. On the reception side, the setting of the ‘Receiver Editability’ returns to the setting before entering the communication state.

The operation of the start button 15 brings the communication peer into the communication state while the ‘Yes/Enable’ is set to ‘Enable’ as it is on the transmission side in the non-communication state (operation C). At this moment, the ‘No’ button 19 of the ‘Receiver Editablility’ is flashing on the reception side then the user recognizes that the ‘No/Enable’ is set to ‘Enable’.

While making the communication, when the ‘Stop’ button 16 is operated in the state that the ‘Yes/Enable’ is ‘Enable’ (operation D), the communication state turned to the non-communication state while setting the ‘Yes/Enable’ is ‘Enable’ as it is on the transmission side. On the reception side, the setting of the ‘Receiver Editability’ returns to the setting before the communication state.

In the communication state, when the user operates the ‘Yes’ button 18 in a state that the ‘Receiver Editablity’ on the reception side sets the ‘No/Enable’ button is ‘Enable’, the ‘Yes/Enable’ is set to be ‘Enable’. At this moment, on the reception side, the ‘Yes/Enable’ becomes ‘Enable’ to light the ‘Yes’ button 18.

While making the communication, if the user operates the ‘No’ button 19 in a state that the ‘Receiver Editability’ on the reception side sets the ‘Yes/Enable’ button to ‘Enable’, the ‘No/Enable’ turns to be ‘Enable’ and the ‘No’ button 19 is lit.

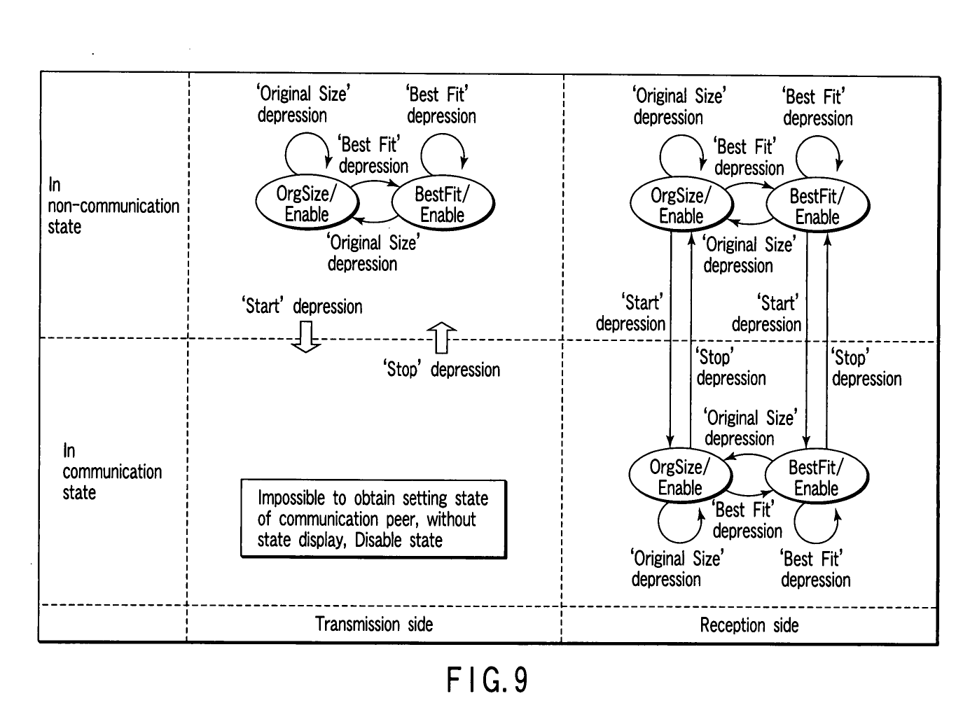

The transitions of the setting state/operable state of each button 23 and 24 of the ‘Material Window View Mode:’ 21 will be described by referring to FIG. 9.

In the non-communication state, the user can operate an ‘Original Size’ button 23 and a ‘Best Fit’ button 24. When the ‘Start’ button 15 is operated to turn the non-communication state into the communication state, the ‘Original Size’ button 23 and the ‘Best Fit’ button 24 cannot be operated on the transmission side. Since the setting of the ‘Material Window View Mode:’ 21 on the reception side does not influence the transmission side, the setting on the reception side is also not displayed.

On the reception side, the setting of the ‘Material Window View Mode:’ 21 in the non-communication state is set to ‘Enable’ as an initial setting. The user can operate the ‘Original Size’ button 23 and the ‘Best Fit’ button 24, then the setting based on the operations becomes ‘Enable’.

When the ‘Stop’ button 16 is operated and the communication state turned into the non-communication state, the setting of the ‘Material Window View Mode:’ 21 returns to the setting before entering the communication state. On the reception side, the setting in the communication state turns to the initial setting.

The above-mentioned user interface has both user interface functions for operation and for state display; an area on a screen can be displayed by saving it with serving both as an operation area and a state display area on the user interface.

By making an operation interface (for example, button) have a function to display a setting state, the operations and the confirmation of the current state by the user are integrated into one action and the operation interface is improved in its operability.

The user can confirm the mutual states by displaying a state of an opposite party side on a state display user interface on its self side depending on the situation.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image communication method for transmitting image data between a first terminal and a second terminal via a network, the method comprising:
performing a bidirectional image communication including a transmission of first image data from the first terminal to the second terminal and a transmission of second image data from the second terminal to the first terminal;
performing a notification to stop either transmission of the first image data or the second image data from one to the other of the first terminal and the second terminal; and
stopping either the transmission of the first image data or the second image data depending on the notification to perform a one-way image communication between the first terminal and the second terminal.

2. The image communication method according to claim 1, further comprising
displaying the first image data within a first window of a display unit of the second terminal and displaying the second image data within a second window of a display unit of the first terminal, and
closing the first window when the transmission of the first image data is stopped and closing the second window when the transmission of the second image data is stopped.

3. The image communication method according to claim 1, wherein the notification is performed depending on a load of processing of the first terminal.

4. The image communication method according to claim 1, wherein the notification is performed depending on a load of the network.

5. The image communication method according to claim 1, wherein the first image data and the second image data are prepared on the basis of first image setting,
the method further comprises
performing a notification of second image setting from one to the other of the first terminal and the second terminal, and
performing a bidirectional image communication including a transmission of third image data based on the second image setting from the first terminal to the second terminal and including a transmission of fourth image data based on the second image setting from the second terminal to the first terminal.

6. The image communication method according to claim 5, wherein the notification of the second image setting comprises
detecting a load of processing by either the first terminal or the second terminal, and
deciding the second image setting depending on the load by either the first terminal or the second terminal which has detected the load.

7. The image communication method according to claim 5, wherein the notification of the second image setting comprises
detecting a load of the network by either the first terminal or the second terminal, and
deciding the second image setting depending on the load.

8. The image communication method according to claim 1, further comprising
detecting by one of the first terminal and the second terminal whether or not image data transmitted from the other of the first terminal and the second terminal has been received normally, and
displaying information showing that the image data has not been received normally onto a display device of either the first terminal or the second terminal.

9. The image communication method according to claim 8, wherein the information is a still image corresponding to the image data which has been received normally for the last time.

10. A communication apparatus to perform an image communication via a network, comprising:
bidirectional image communication means for performing a reception of first image data transmitted from an opposite party's terminal and a transmission of second image data to the opposite party's terminal; and
one-way image communication means for stopping a transmission of either the reception of the first image data or the transmission of the second image data to perform a one-way image communication with the opposite party's terminal when a stoppage of either transmission of the first image data or the second image data has been notified from the opposite party's terminal.

11. The communication apparatus according to claim 10, further comprising, a display device; and
a window control unit which displays the first image data within a first window of the display device and when a stoppage of a transmission of the first image data is notified, closes the first window.

12. The communication apparatus according to claim 11, further comprising,
a monitoring unit to monitor whether or not the first image has been received normally, wherein the window control unit displays, within the first window, information showing the fact that the first image data has not been received normally when the first image data has not been received normally.

13. The communication apparatus according to claim 12, wherein the window control unit displays, within the first window, a still image corresponding to the first image data which has been received normally for the last time, as the information.

14. The communication apparatus according to claim 11, further comprising, an image data generation unit which generates the second image data on the basis of first image setting, wherein
the image data generation unit generates the second image data based on second image setting when the second image setting is notified from the opposite party's terminal, and
the bidirectional image communication means performs a transmission of the second image data, generated on the basis of the second image setting, to the opposite party's terminal.

15. A communication apparatus to perform an image communication via a network, comprising:
bidirectional image communication means for performing a reception of first image data transmitted from an opposite party's terminal and a transmission of second image data to the opposite party's terminal;
notification means for notifying a stoppage of a transmission of either the first image data or the second image data to the opposite party's terminal; and
one-way image communication means for stopping either the reception of the first image data or the transmission of the second image data to perform a one-way image communication when the notification means has notified the stoppage of the transmission of either the first image data or the second image data to the opposite party's terminal.

16. The communication apparatus according to claim 15, further comprising,
a display device; and an image data processing unit which performs processing to generate the second image data and/or to display the first image data onto the display device, wherein
the notification means notifies to stop a transmission of either the first image data or the second image data depending on a load of the image data processing unit.

17. The communication apparatus according to claim 15, wherein the notification unit notifies to stop a transmission of either the first image data or the second image data depending on a load of the network.

18. The communication apparatus according to claim 15, further comprising,
an image data generation unit which generates the second image data on the basis of first image setting, and
a setting notification unit which generates second image setting to notify the generated second image setting to the opposite party's terminal, wherein
the image data generation unit generates the second image data based on the second image setting when the setting notification unit notifies the second image setting to the opposite party's terminal; and
the bidirectional image communication means performs a transmission of the second image data, generated on the basis of the second image setting, to the opposite party's terminal.

19. The communication apparatus according to claim 18, further comprising:
an image data processing unit which performs processing to display the first image data onto the display device, wherein the setting notification unit generates the second image setting depending on at least either a load of the image data generation unit or a load of the image data processing unit.

20. The communication apparatus according to claim 18, wherein the setting notification unit generates the second image setting depending on a load of the network.
